(19) United States
(12) Patent Application Publication
(10) Pub. No.: US 2017/0212579 A1
(43) Pub. Date: Jul. 27, 2017

(54) Storage Device With Power Management Throttling

(71) Applicant: Avago Technologies General IP (Singapore) Pte. Ltd., SG (SG)

(72) Inventors: Anup S. Tirumala, San Jose, CA (US); John Jansen, Macungie, PA (US); Kavitha Chaturvedula, Milpitas, CA (US); Suresh Babu Mv, Bangalore (IN)

(21) Appl. No.: 15/006,022

(22) Filed: Jan. 25, 2016

(51) Int. Cl. G06F 1/32; G06F 13/16; G06F 5/14; G06F 13/42

(52) U.S. Cl. CPC G06F 1/3287; G06F 13/4291; G06F 13/1673; G06F 5/14

(57) ABSTRACT

An apparatus for throttling traffic on a bus includes an electronic client device, a host device, and a bus protocol circuit connected between the electronic client device and the host device. Data transfers between the electronic client device and the host device are controlled by the bus protocol circuit by tracking credits. The bus protocol circuit is configured to throttle traffic between the electronic client device and the host device when signaled by a throttle signal from the electronic client device.

### FIELD OF THE INVENTION

The present invention is related to systems and methods for power management throttling in storage devices, and specifically in some cases, in PCI Express solid state storage devices.

### BACKGROUND

Peripheral Component Interconnect Express (PCIe) is a high-speed electronic bus commonly used in computer systems for connecting peripheral devices such as storage devices to a motherboard. A PCIe bus is a highly optimized serial bus with point to point serial connections. Multiple devices can be connected to the bus using a switch to route communication, thus each device has dedicated connections avoiding the need to share connections among multiple devices. Physical connections in the PCIe bus are made by low-voltage differential pairs, with one differential pair used for a transmit portion of a lane and another differential pair used for a receive portion of a lane.

Transaction requests are generated by a root complex or host on behalf of the processor on the motherboard. The transaction requests are transmitted via the PCIe bus to the peripheral device. The peripheral device processes the transaction requests, for example writing data or reading data and transmitting the requested data back to the host via the PCIe bus.

Bandwidth throttling, where-in activity is intentionally stopped for programmed periods of time, can occur in two ways.
Directed by the host when the temperature in the system as a whole is measured to be at or near a threshold.
Self-directed by the device itself when its own die/package temperature, or media reliability is measured to be at risk.

Currently, the de-facto standard method for a device to throttle itself is by stopping or slowing the execution of commands for a programmed duration, so that it may apply power reduction measures on the media interfaces (Flash, DRAM, etc.) and related logic it controls.

### BRIEF DESCRIPTION OF THE FIGURES

A further understanding of the various embodiments of the present invention may be realized by reference to the figures which are described in remaining portions of the specification. In the figures, like reference numerals may be used throughout several drawings to refer to similar components.

FIG. 1 depicts a block diagram of a PCI Express solid state drive (SSD) storage device with end-point initiated traffic throttling in accordance with some embodiments of the present invention;

FIG. 2 depicts a block diagram of credit management in a PCI Express layer for end-point initiated traffic throttling in accordance with some embodiments of the present invention; and

FIG. 3 is a flow diagram illustrating an example method for end-point initiated power management throttling in a PCI Express device in accordance with some embodiments of the present invention.

### DETAILED DESCRIPTION OF THE INVENTION

The present invention is related to systems and methods for power management throttling in storage devices, and specifically in some cases, in Peripheral Component Interconnect Express (PCI Express or PCIe) solid state storage devices. The PCIe end-point device can be any electronic device with a PCI Express interface, such as, but not limited to, solid state storage devices and other disk storage devices, and is referred to generically herein as an electronic client device. The throttling of traffic or bandwidth can be performed, for example, for thermal reasons and for media reliability. The throttling is initiated by the PCIe end-point device, e.g., by a solid state storage device (SSD), rather than by a host or root complex. The SSD or other device back-pressures the originator of storage commands on the PCIe bus, leveraging this back-pressure for improved power savings without enforcing retraining of the physical link.

In some embodiments, the PCIe stack is made aware of the throttling using an explicit handshake with the app-layer. In some other embodiments, the PCIe stack is made aware of the throttling when its ingress buffers are not de-staged by the app-layer for a programmable amount of time. For the duration of the throttling, key portions of the serializer/deserializer (Serdes) are thus able to realize deeper power saving measures than is otherwise possible when the PCIe link is still up.

The power management throttling disclosed herein can be applied in several clocking modes. In a common-clock mode, more power can be saved than is normally achieved in the L0s standby pseudo sub-state of active state L0. In a separate reference clock independent spread spectrum clocking (SSC) Architecture (SRIS) clocking mode, receiver power can be saved even though in this clocking mode the L0s standby pseudo sub-state of active state L0 is not supported by the PCIe standard.

The term throttling is used herein to refer to an intentional halt or reduction in activity on the bus to the end-point device. The throttling can be performed for a programmed period of time, or until a condition that triggered the throttling has ended. The throttling is self-directed by the end-point device when its own die/package temperature exceeds a threshold or is otherwise identified as being excessive or in need of reduction or control, or when the end-point device has detected an internal problem that warrants throttling for any reason, such as, but not limited to, a determination that media reliability in a storage device is at risk. Such self-directed throttling enables the end-point device to initiate throttling in response to internal conditions detected by the end-point device. This end-point directed throttling is in contrast to host-directed power management techniques in which a controlling entity, such as the main CPU in a server, directs the power management in response to system level metrics, for example when the temperature in the system as a whole is measured to be at a threshold.

Furthermore, the throttling initiated by an end-point device disclosed herein provides for power savings at the PCIe layer, beyond that achieved when the end-point device throttles itself by stopping the execution of commands for a programmed duration to apply power reduction measures on the media interfaces (Flash, DRAM, etc.) and related logic it controls.

Throttling can be triggered in response to any detected condition, and in some embodiments, is likely to occur when there is a high level of activity on the PCIe link. Such activity can be broadly categorized as follows:

1. Execution of SSD related input/output (I/O) commands such as reads and writes.

2. Access of PCIe architected registers such as message-signaled interrupt (MSI-X) mask and pending bit arrays by the host.

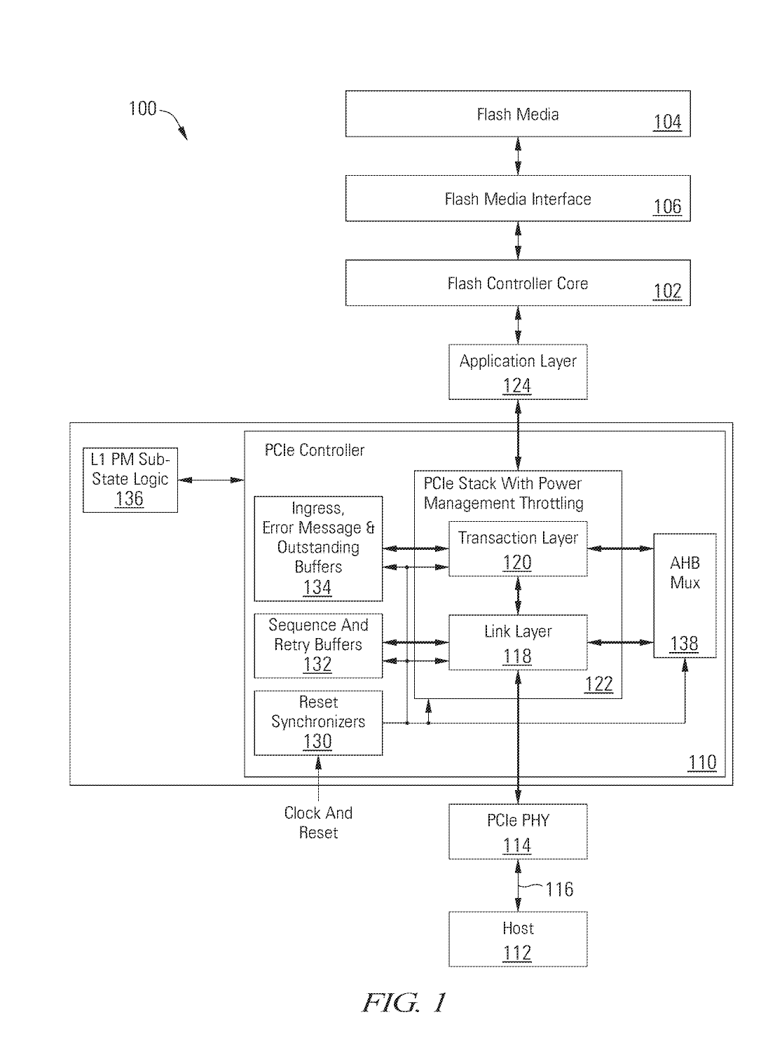

Turning to FIG. 1, a block diagram of a PCI Express solid state drive (SSD) storage device 100 with end-point initiated traffic throttling is depicted in accordance with some embodiments of the present invention. A flash controller core 102 or solid state drive controller manages a flash media 104 through a flash media interface 106, such as, but not limited to, an Open NAND Flash Interface (ONFI) or a toggle-mode interface. The flash controller core 102 maps physical layer abstractions that the flash media circuits manage, to the logical layer abstractions that the PCIe layer manages.

A PCIe controller 110 provides an interface between the flash controller core 102 and a host 112. Generally, the PCIe is a packet-based protocol processed in a series of layers in the PCIe controller 110, although the end-point initiated traffic throttling disclosed herein can be applied to any suitable bus circuits. Based upon the disclosure provided herein, one of ordinary skill in the art will recognize a variety of bus circuits that can be used in relation to different embodiments of the present invention.

In some embodiments, a physical layer PCIe PHY 114 interfaces with a set of serial connections 116 to the host 112 or another device on the PCIe bus. The physical layer 114 generally comprises a serializer/deserializer (SerDes) circuit that performs parallel-to-serial and serial-to-parallel conversion, impedance matching, driver and input buffers, etc. The PCIe controller 110 comprises a data link layer 118 and a transaction layer 120 which collectively form a PCIe stack 122, also referred to herein genetically as a bus protocol circuit. The transaction layer 120 is primarily responsible for packetizing and depacketizing transaction layer packets (TLPs), which can include headers and data, including information for transactions such as read, write and configuration. The link layer 118 is an intermediate layer between the physical layer 114 and the transaction layer 120, performing link management, error detection and error correction. An application layer 124 between the transaction layer 120 and the flash controller core 102 provides compatibility with operating systems and device drivers.

The diagram of FIG. 1 provides a view of the PCIe layers implemented by the PCIe controller 110. Again, the end-point initiated traffic throttling disclosed herein is not limited to any particular PCIe circuits, and any suitable PCIe circuit can be configured to implement the end-point initiated traffic throttling. Thus, other desired circuits can be included in the PCIe controller 110 of FIG. 1, such as, but not limited to, clock and reset synchronizer circuits 130, sequence and retry buffers 132, ingress, error message and outstanding buffers 134, L1 power management sub-state logic 136, bridges 138 to other busses such as an advanced high-performance bus (AHB), etc.

The serial connections 116 can include serial receive and transmit connections, and the physical layer 114, the link layer 118 and transaction layer 120 can be divided into receive and transmit lanes.

In the receive lane, the physical layer 114 receives and decodes incoming packets from the host 112 on differential serial connections 116 and forwards the resulting contents to the link layer 118, which checks the packet for errors. If the packet is error-free, the link layer 118 forwards the packet to the transaction layer 120, which buffers incoming transaction layer packets and converts the information in the packets to a representation that can be processed by the flash controller core 102 and application layer 124.

In the transmit lane, packet contents are formed in the transaction layer 120 with information obtained from the flash controller core 102 and application layer 124. The packet is stored in buffers ready for transmission to the lower layers. The link layer 118 adds additional information to the packet required for error checking at the host 112 or other receiver device. The packet is then encoded in the physical layer 114 and is transmitted differentially on the serial connections (or link) 116 to the host 112.

For example, during a write operation initiated by the host 112, the host 112 issues commands to the flash controller core 102 through the PCIe controller 110 using PCIe transactions, for example to write a given number of blocks identified by logical block addresses (LBAs). The flash controller core 102 maps the logical block addresses to physical block addresses used by the flash media 104. Commands can be received by the PCIe controller 110 at high rates based on the design of the PCIe controller 110 and the flash controller 102. As commands are processed at high rates, the flash controller core 102 can get hot, or the flash media 104 can get hot due to self-heating. The flash controller core 102 can reduce the temperature by artificially extending the time required to process commands. For example, if the host 112 issues a command to read a certain number of blocks from the flash media 104, and the flash controller core 102 and/or flash media 104 is undesirably hot, the flash controller core 102 can artificially extend the amount of time between read operations to allow the flash controller core 102 and/or flash media 104 to cool by reducing the dynamic power, the charging and discharging of transistor load capacitances in the CMOS circuits. However, while these artificial delays in processing commands applied by the flash controller core 102 can reduce dynamic power consumption and allow the circuits to cool, the host 112 can continue to send commands to the PCIe controller 110, consuming power in the PCIe link as the serial connections 116 are toggled and slowing cooling.

The end-point initiated traffic throttling enables the flash controller core 102 to signal the PCIe stack 122 that throttling is being implemented, enabling the PCIe stack 122 to reduce or temporarily halt activity on the serial connections 116 and in the PCIe controller 110 to further reduce power consumption during throttling. This signaling to the PCIe stack 122 enables the PCIe stack 122 to participate in power savings during traffic throttling, both by delaying commands from the host 112 to the flash controller core 102 and by reducing access to the PCIe stack 122 itself. The flash controller core 102 can thus implement any throttling or power reduction techniques desired, in conjunction with power management throttling in the PCIe stack 122 that allows the PCIe controller 110 and physical layer 114 to also cool down.

In some embodiments, the end-point initiated traffic throttling enables the PCIe stack 122 to reduce receive (Rx) activity and power consumption, which can in some cases generate substantially more power and heat than transmit (Tx) activity.

The PCIe controller 110 circuit, and specifically in some cases, the PCIe stack 122, is thus configured in some embodiments with throttle signals enabling the flash controller core 102 circuit to indicate when throttling is applied. This allows the PCIe layer to also throttle itself when the flash controller core 102 is throttling, so that the dynamic power in the overall integrated circuit or application specific integrated circuit is reduced during throttling so that the core temperature falls faster.

The PCIe protocol has a standardized dynamic flow control mechanism to match the rates of production with the rates of consumption across the physical link, where flow control is defined as “The method for communicating receive buffer status from a Receiver to a Transmitter to prevent receive buffer overflow and allow Transmitter compliance with ordering rules.” Receiver buffer status is represented and advertised in terms of “credit units”. Four of the six types of PCIe receiver buffer status credits that are most germane to solid state devices are represented in Table 1:

TABLE 1

| Type | Host Initiated | SSD Initiated |
|---|---|---|
| PH | PCIe Memory Mapped | SSD executing Read |
| (Posted Request | Writes; NVMe Doorbell/ | command as Read DMA; |
| Header) | Configuration updates | MSI-X (posting of |
| | | interrupts) |
| PD (Posted Request | PCIe Memory Mapped | SSD executing Read |
| Data Payload) | writes; NVMe Doorbell/ | command as Read DMA; |
| | Configuration updates | MSI-X (posting of |
| | | interrupts) |
| NPH (Non-Posted | PCIe Memory Mapped | SSD fetching commands |
| Request Header) | Reads; PCIe Configura- | from Host memory; SSD |
| | tion reads and writes | executing Write com- |
| | | mand as Write DMA |
| NPD (Non-Posted | PCIe Configuration | — |
| Request Data | writes | |
| Payload) | | |

As shown in Table 1, Non-Volatile Memory Express (NVMe) doorbells are a host-initiated mechanism for the host 112 to inform the SSD (flash controller 102, flash media interface 106, flash media 104) of the status of its architected queues, i.e., when new SSD commands are available and when the results of prior commands have been processed. Direct memory access (DMA) is an SSD-initiated mechanism for the SSD to deposit the results of a prior SSD command issued by the host 112 without involving precious CPU cycles in the host 112.

During SSD throttling applied by the flash controller 102, there are two ways in which the SSD can exert back-pressure on the PCIe layer one is by the flash controller core 102 itself not de-staging incoming PCIe traffic when throttling is enabled, which would at some point cause the SSD's receive buffers to fill up and stall incoming traffic because the host 112 runs out of related credit types. The other is for the PCIe layer (PCIe controller 110/PCIe stack 122) to participate in throttling by depleting receiver credits sooner than the former approach and in a manner than can be advantageous for power minimization. If the credits are exhausted, the remote transmitter or the host 112 in this case cannot send any commands or any PCIe traffic because there are no credits available. Both approaches are compatible with the PCIe standard, and one or both can be applied in accordance with various embodiments of the invention. The end-point initiated traffic throttling disclosed herein thus causes the PCIe controller 110 to artificially and in a controlled fashion allow credits to be exhausted to reduce or stop traffic on the PCIe link, specifically allowing SerDes Rx power at the physical layer 114 to be reduced in response to self-heating issues.

Again, the end-point initiated traffic throttling disclosed herein can be applied in several clocking modes. In a common-clock mode, more power can be saved than is normally achieved in the L0s standby pseudo sub-state of active state L0. In a separate reference clock independent spread spectrum clocking (SSC) Architecture (SRIS) clocking mode, receiver power can be saved even though in this clocking mode the L0s standby pseudo sub-state of active state L0 is not supported by the PCIe standard. Although the SRIS clocking mode does not support the L0s power mode, the end-point initiated traffic throttling enables the PCIe controller 110 to still go into a deep low power state despite the lack of L0s support. The PCIe stack 122 supports both modes of deployment. In the common-clock mode, the PCIe stack 122 has to wake up periodically, for example every 30 microseconds, in order to send a handshake packet. In the SRIS clocking mode, it does not have to wake up periodically to send a handshake and more power can be conserved.

Again, the flash controller core 102 can operate to throttle traffic and apply back-pressure on the PCIe layer in any suitable manner, such as, but not limited to, not de-staging incoming PCIe traffic when throttling is enabled to cause the SSD's receive buffers to fill up and stall incoming traffic because the host 112 runs out of related credit types, and instructing the PCIe layer to participate in throttling by depleting receiver credits sooner than the former approach and in a manner than can be advantageous for power minimization. In the latter approach, the PCIe stack 122 does not advertise incremented receiver credits so at some point the host 112 gets back-pressured (i.e., bandwidth is throttled). The PCIe layer is informed that throttling is desired so optimizations can be made. The duration of throttling can be indicated either in terms of time, for example in microseconds, or asynchronously by the flash controller core 102 through interface control signals to the PCIe stack 122.

Once the SSD's receive buffers are full, the SerDes lanes in physical layer PCIe PHY 114 can be made to go into a much lower power state than usual depending on the duration of the throttle.

In the common clock mode, power modes Tx.L0s and Rx.L0s are available and may be entered at different times. The PCIe standard requires that a credit update be transmitted every 30 us, although this may be delayed a given amount, so Tx.L0s can be entered and exited based on this requirement. Rx.L0s, now that the PCIe stack 122 is aware that throttling is in progress, can allow the SerDes lanes in physical layer PCIe PHY 114 to go into a much deeper low power state than normal Rx.L0s, leveraging the fact that receiver buffers are full and it can ignore any incoming traffic from host 112 until receive buffers entries are de-staged by the flash controller 102. The same is true for separate reference clock mode without spread spectrum clocking.

In the separate reference clock independent SSC Architecture (SRIS) clocking mode, the PCIe standard does not support Tx.L0s and Rx.L0s power modes, and in this case, the receiver SerDes lanes in physical layer PCIe PHY 114 can still go into a deep low power state despite the missing Rx.L0s power mode.

Again, in some embodiments, most power dissipation in the SerDes lanes in physical layer PCIe PHY 114 occurs in the receive portion. In order to enable greater savings of power in the receiver, the PCIe stack 110 is configured according to some or all of the following characteristics A-J:

A. Implement a handshake mechanism with application layer 124 or external logic to enter and exit throttling, for example using a ThermalThrottle_in signal to the PCIe stack 122 from the application layer 124 when the flash controller core 102 or other end-point controller has requested throttling.

B. Implement an internal “throttle-state” signal that indicates to internal logic that the SerDes receive lanes in physical layer PCIe PHY 114 can be turned off. The throttle-state signal will be asserted when standard-compliant conditions are fulfilled—i.e., receiver PH, PD, NPH, NPD credits are exhausted after application layer 124 or external logic has indicated that throttling is desired.

C. Stop egress or transmission of Non-Posted packets when the “throttle state” is attained, since the PCIe receiver is going to go into a low power state. For example, if the host 112 issues a write command to write data to the flash media 104 at a range of logical block addresses, the host 112 will expect the flash controller core 102 to fetch the blocks that are to be written from the host memory in a direct memory access (DMA) operation and to commit those blocks to the flash media 104. From the perspective of the host 112, a write DMA operation must be performed, from the perspective of the flash controller core 102 a read operation is performed because it reads the blocks from the host memory. The flash controller core 102 thus issues PCIe read packets to read the range of memory addresses, through Non-Posted transactions originated by the flash controller core 102. If there are any pending reads from the PCIe perspective they are finished before initiating throttling, by stopping egress of Non-Posted packets. Only the PCIe controller 110 is aware when egress of Non-Posted packets can be stopped in some embodiments, so if there are any Non-Posted packets pending entry into the throttle mode is postponed until the pending reads are complete.

D. Stop egress of Posted packets when “throttle state” is attained. In some embodiments, allow Read DMA traffic, but do not allow interrupts to go out.

E. Do not actually enter throttle-mode until all pending Completions are seen through to the application layer 124. Completions have “infinite credits” so should never be stopped.

F. Drive appropriate control signals, such as a ThermalThrottle_out signal, to SerDes receive lanes in physical layer PCIe PHY 114 so that physical layer PCIe PHY 114 can take power savings measures. Note that clock and data recovery (CDR) relock is not possible for exiting in some embodiments for these power savings measures, so only a subset of Serdes Rx power modes are utilized in these cases.

G. Continue to transmit UpdateFC data link layer Packets (DLLPs) every 30 us-200 us and as programmed. In between UpdateFC DLLPs, Serdes Tx lanes can take power saving measures if clock mode allows it.

H. Account for any unprocessed ACK, NAK or UpdateFC DLLPs issued by the host 112 for the period that the receiver is in a deep low power state. If implementation requires that ACK/NAKs be completely processed by a Replay buffer before powering down Serdes RX, there may be no ACK/NAK adjustments required.

I. Gate a replay timer in the PCIe stack 122 so no timeout occurs for the throttle duration. Also gate any further interrupts from going out when NPH, NPD are exhausted. (In some embodiments, interrupts will require MSI-X capability structure to be read and written to so allow interrupts to go through until then.)

J. After throttle duration has expired, when the next egress Posted transaction is sent out, use the corresponding ACK/NAK from host 112 to flush out unneeded Retry buffer entries (as applicable).

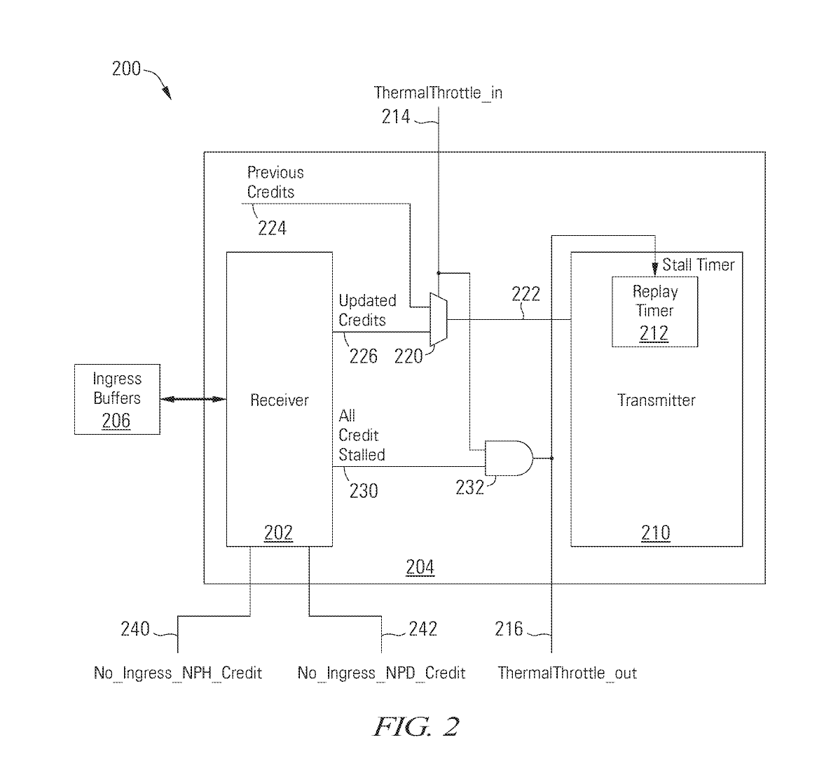

Turning now to FIG. 2, a PCIe layer 200 is depicted with credit management for end-point initiated traffic throttling in accordance with some embodiments of the present invention. The PCIe layer 200 receives a ThermalThrottle_in signal 214 from an end-point device, such as the flash controller core 102 of a solid state drive, indicating that throttling should be initiated. For example, the flash controller core 102 of a solid state drive may measure its temperature as being over a threshold, or quality metrics may indicate that the reliability of the flash media 104 is at risk. The ThermalThrottle_in signal 214 is a level input signal, indicating to the PCIe stack 204 that the end-point device (e.g., SSD) wants to be in a throttle condition such as a thermal throttle. The ThermalThrottle_in signal 214 can be generated by the application layer (e.g., 124) or external logic.

The PCIe layer 200 also generates a ThermalThrottle_out signal 216 to inform a physical layer PCIe PHY 114 and/or host 112 that the link is being throttled, enabling the physical layer PCIe PHY 114 and/or host 112 to also implement power saving operations. The ThermalThrottle_out signal 216 is a level output signal, provided to the PCIe physical layer PHY/SerDes (e.g., 114) to indicate that the end-point device (e.g., SSD) is in a throttling operation such as a thermal throttle. The ThermalThrottle_out signal 216 enables the PCIe physical layer PHY/SerDes (e.g., 114) to place its receive lanes in any possible low power mode.

A receiver 202 is provided in a PCIe stack 204, and packets for the receiver 202 are buffered in ingress buffers 206. A transmitter 210 is also provided in the PCIe stack 204. The receiver 202 and transmitter 210 may comprise receivers and transmitters at any layer of the PCIe stack 204, such as the data link layer. A replay timer 212 in the transmitter 210 counts the time since the last Ack or Nak DLLP was received, running anytime there is an outstanding transaction layer packet and being reset every time an Ack or Nak DLLP is received. If a Nak DLLP is received or the replay timer 212 expires, the transmitter 210 begins a retry.

The transmitter 210 receives a credit indication 222 from a multiplexer 220 which selects either the previous credits 224 or updated credits 226 from the receiver 202, based on whether the ThermalThrottle_in signal 214 indicates that the system is throttling.

The PCIe stack 204 generates the ThermalThrottle_out signal 216 by combining the ThermalThrottle_in signal 214 with an AllCreditStalled signal 230 from the receiver 202 in AND gate 232. The ThermalThrottle_out signal 216 is used to stall the replay timer 212 in the transmitter 210 when the system is throttling per the ThermalThrottle_in signal 214 and the receiver 202 has asserted the AllCreditStalled signal 230.

The application layer (e.g., 124) will assert ThermalThrottle_in 214 to initiate thermal throttling, which can be initiated by an end-point device such as a solid state drive or external logic. The application layer should assert ThermalThrottle_in 214 after receiving completions for all pending egress Non-Posted Requests and stalling further Egress Non-Posted Requests. In some embodiments, the PCIe controller may choose to wait until any already pending Posted Requests have been acknowledged by the link partner before placing the SerDes receiver in a low power mode.

When ThermalThrottle_in 214 is asserted, the transaction layer will stop sending UpdateFC DLLPs with updated credits. It continues to send UpdateFC DLLPs with the previous sent credits. When all ingress credits are depleted (with buffer space still physically available in ingress buffers 206), AllCreditStalled 230 is asserted by the receiver 202. On assertion of AllCreditStalled 230, ThermalThrottle_out 216 is asserted to indicate that the PCIe physical layer PHY/SerDes can enter a low power mode and the replay timer 212 is stalled, preventing the transmitter 210 from initiating retries during throttling.

When ThermalThrottle_in 214 is de-asserted, the replay timer 212 runs as normal, UpdateFC DLLPs are sent normally and ThermalThrottle_out 216 is de-asserted. The PCIe physical layer PHY/SerDes should return to an normal operating mode when ThermalThrottle_out 216 is de-asserted. The PCIe stack 204 should ignore any partial packets detected on exit from thermal throttling.

In some embodiments, the receiver 202 also generates a No_Ingress_NPH_Credit signal 240 and a No_Ingress_NPD_Credit signal 242. The No_Ingress_NPH_Credit signal 240 is asserted by receiver 202 when there are no ingress NPH credits. When this signal 240 is asserted, the Application layer should stop issuing any Posted TLPs that result in ingress configuration requests, for example, MSI/MSI-X assertion using memory write can trigger ingress configuration request. The No_Ingress_NPD_Credit signal 242 is asserted by receiver 202 when there are no ingress NPD credits. When this signal 242 is asserted, the Application layer should stop issuing any Posted TLPs that result in ingress configuration requests.

In some embodiments, the throttling disclosed herein is used in lieu of existing power management methods, although it can be used together with other techniques of extending command execution times. In some cases, for example, throttle durations are on the order of tens of microseconds with upper limit throttling durations being set for example at about 20 microseconds, although all time values set forth herein should be seen as merely non-limiting examples.

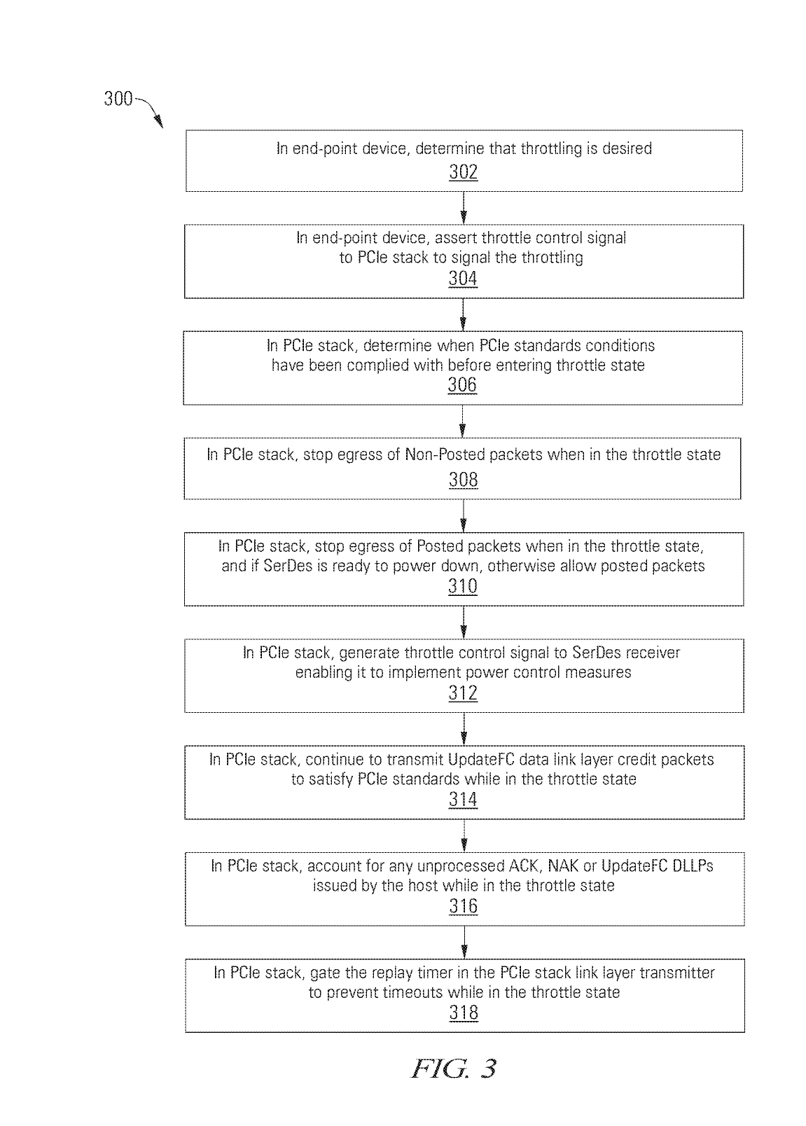

Turning now to FIG. 3, a flow diagram 300 illustrates an example method for end-point initiated power management throttling in a PCIe device in accordance with some embodiments of the present invention. The peripheral device can be any type of electronic device with a PCI Express interface, such as, but not limited to, a solid state drive or other storage device.

Following flow diagram 300, an end-point device or external logic circuits external to the end-point device determines that throttling is desired. (Block 302) The end-point device can be any PCIe device such as, but not limited to, a solid state drive. The throttling can be initiated for any reason, such as detecting temperatures in the solid state drive that exceed a threshold, or calculating metrics that indicate that the reliability of the solid state drive is at risk, etc. The end-point device asserts a throttle control signal to the PCIe stack to signal the throttling. (Block 304) The PCIe stack determines when PCIe standards conditions have been complied with before entering throttle state. (Block 306) For example, this can include determining that data link layer receiver PH, PD, NPH, NPD credits are exhausted. This can also include delaying entry to throttle state until all pending Completions are seen through to the application layer. The PCIe stack stops egress of Non-Posted packets when in the throttle state, since the link layer receiver is going to enter a low power state. (Block 308) The PCIe stack also stops egress of Posted packets when in the throttle state, and if SerDes is ready to power down, otherwise Posted packets are allowed. (Block 310) The PCIe stack generates a throttle control signal to the SerDes receiver enabling it to implement power control measures. (Block 312) The PCIe stack continues to transmit UpdateFC data link layer credit packets to satisfy PCIe standards while in the throttle state. (Block 314) The PCIe stack accounts for any unprocessed ACK, NAK or UpdateFC DLLPs issued by the host while in the throttle state. (Block 316) The PCIe stack gates the replay timer in the PCIe stack link layer transmitter to prevent timeouts while in the throttle state. (Block 318) In some embodiments, after the throttle duration has expired, when the next egress Posted transaction is sent out by the link layer transmitter, the corresponding ACK/NAK from the host is used to flush out unneeded Retry buffer entries.

In some embodiments, the PCIe stack also profiles throttling, for example determining if current throttling intervals actually caused a throttle to occur, and if so, for how long, and if not, a measurement of the gap between current and max credit buffers. Such profiling is performed using counters, for example, to measure throttling durations and count throttling events, registers that can be updated with counter values to report various information about the throttling, etc.

The end-point initiated traffic throttling disclosed herein enables the PCIe layer to apply power saving measures when an end-point device on the PCIe bus determines that throttling is needed. In particular, this can reduce power usage in the link layer receiver of a PCIe stack during throttling, which can help the end-point device such as a solid state drive to cool faster than if power management techniques were applied by the end-point device alone.

In conclusion, the present invention provides novel systems, apparatuses and methods for end-point initiated power management throttling in a Peripheral Component Interconnect Express (PCIe) device. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus for throttling traffic on a bus, comprising:
an electronic client device;
a host device; and
a bus protocol circuit connected between the electronic client device and the host device, wherein data transfers between the electronic client device and the host device are controlled by the bus protocol circuit by tracking credits, and wherein the bus protocol circuit is configured to throttle traffic between the electronic client device and the host device when signaled by a throttle signal from the electronic client device.

2. The apparatus of claim 1, wherein the bus protocol circuit comprises a Peripheral Component Interconnect Express (PCIe) controller, and wherein the electronic client device comprises a solid state storage device.

3. The apparatus of claim 1, wherein a controller core in the electronic client device throttles the traffic by not de-staging incoming PCIe traffic, causing receive buffers in the bus protocol circuit to fill and stall incoming traffic.

4. The apparatus of claim 1, wherein the bus protocol circuit is configured to throttle the traffic by not advertising incremented receiver credits.

5. The apparatus of claim 1, wherein the electronic client device is configured to indicate to the bus protocol circuit a time duration for the throttling.

6. The apparatus of claim 1, wherein the throttle signal from the host device to the bus protocol circuit comprises an asynchronous control signal.

7. The apparatus of claim 1, wherein the bus protocol circuit is configured to enter a low power state during the throttling when receive buffers are full.

8. The apparatus of claim 7, wherein the low power state comprises a Rx.L0s power state in a common clock mode.

9. The apparatus of claim 1, wherein the bus protocol circuit comprises a PCIe stack and a PCIe physical layer, and wherein the a PCIe stack in the bus protocol circuit is configured to generate a second throttle signal to a PCIe physical layer to indicate to the PCIe physical layer that the traffic is throttled.

10. The apparatus of claim 9, wherein the PCIe physical layer is configured to enter a power saving state when the second throttle signal is asserted.

11. The apparatus of claim 10, wherein the bus protocol circuit is configured to operate in a separate reference clock independent spread spectrum clocking architecture clocking mode.

12. The apparatus of claim 1, wherein the bus protocol circuit is configured to delay entry into a throttled state until after bus protocol standards have been satisfied for ongoing transactions.

13. The apparatus of claim 1, wherein the bus protocol circuit is configured to stop egress of non-posted packets when the throttle signal is asserted and receive circuitry in the bus protocol circuit is entering a low power state.

14. The apparatus of claim 1, wherein the bus protocol circuit is configured to stop egress of posted packets when the throttle signal is asserted and receive circuitry in the bus protocol circuit has entered a low power state.

15. The apparatus of claim 1, wherein the bus protocol circuit is configured to prevent the throttling until all pending completion transmissions have been performed to a transaction layer.

16. The apparatus of claim 1, wherein the bus protocol circuit comprises a PCIe stack, and wherein the bus protocol circuit is configured to continue to transmit UpdateFC link layer packets when throttling the traffic.

17. The apparatus of claim 1, wherein the bus protocol circuit comprises a PCIe stack comprising a link layer transmitter with a replay timer, and wherein the bus protocol circuit is configured to stall the replay timer when throttling the traffic.

18. The apparatus of claim 1, wherein the bus protocol circuit is configured to generate a first signal to an application layer indicating when there are no ingress Non-Posted Request Header credits and a second signal to an application layer indicating when there are no ingress Non-Posted Request Data Payload credits.

19. A method for throttling a Peripheral Component Interconnect Express (PCIe) bus, comprising:
receiving in a PCIe stack a throttle control signal from an end-point device indicating that traffic with the end-point device will be throttled;
completing ongoing transactions in the PCIe stack required by PCIe standards before entering a throttled state;
when in the throttled state, generating a second throttle control signal in the PCIe stack to a PCIe physical layer enabling the PCIe physical layer to enter a low power state; and
profiling throttling activity.

20. An electronic communication system comprising:
a Peripheral Component Interconnect Express (PCIe) bus;
an end-point device connected to the bus;
a host device connected to the bus;
a PCIe stack configured to control traffic on the bus between the host device and the end-point device; and
means in the PCIe stack for throttling traffic on the bus in response to a throttle control signal from the end-point device.
